(19) United States
(12) Patent Application Publication
(10) Pub. No.: US 2025/0179867 A1
(43) Pub. Date: Jun. 5, 2025

(54) SECURE BOX ASSEMBLY AND RELATED METHODS

(71) Applicant: GREGORY MEIZINGER, Virginia Beach, VA (US)

(72) Inventor: GREGORY MEIZINGER, Virginia Beach, VA (US)

(21) Appl. No.: 19/047,811

(22) Filed: Feb. 7, 2025

Related U.S. Application Data
(63) Continuation-in-part of application No. 18/973,286, filed on Dec. 9, 2024, now abandoned.
Application No. 18/973,286 is a continuation of application No. 17/663,681, filed on May 17, 2022, now Pat. No. 12,163,373.
(60) Provisional application No. 63/190,286, filed on May 19, 2021.

(51) Int. Cl. E06B 5/01; E05F 3/02; E06B 1/52; E06B 5/02; E06B 5/04; E06B 5/10

(52) U.S. Cl. CPC E06B 5/01; E05F 3/02; E06B 1/52; E06B 5/02; E06B 5/04; E06B 5/10

(57) ABSTRACT

A secure box assembly for a floor structure may include a frame body coupled between joists within the floor structure and defining a cavity therein, an uppermost portion of the frame body being aligned with an upper surface of the floor structure. The secure box assembly may also include a door having a first major surface facing the cavity of the frame body and a second major surface opposite the first major surface, a hinge assembly coupled between the frame body and the first major surface, and a powered arm coupled between the frame body and the first major surface and configured to pivot the door between an open state and a closed state. The door may be flat and flush with the upper surface of the floor structure in the closed state.

### RELATED APPLICATION

This application is a continuation-in-part of application Ser. No. 18/973,286 filed Dec. 9, 2024, which is a continuation of application Ser. No. 17/663,681 filed May 17, 2022, now U.S. Pat. No. 12,163,373, which based upon prior filed copending Application No. 63/190,286 filed May 19, 2021, the entire subject matter of which are incorporated herein by reference in their entireties.

### TECHNICAL FIELD

The present disclosure relates to the field of security, and, more particularly, to a secure box assembly and related methods.

### BACKGROUND

The construction industry is a robust and growing business in the United States. Indeed, with the COVID-19 pandemic causing substantial migration within the population and the shortage of affordable housing in major urban areas, the construction industry has continued to grow. In addition to new construction, the existing construction (i.e., renovation) part of the business has experienced similar growth. With the pandemic changing established work patterns of behavior (e.g., work from home becoming popular), this has inspired many homeowners to reevaluate the functionality of their own home.

In many urban multistory homes, the lowermost level (e.g., basement or cellar) sometimes remains underutilized due to poor access. In most cases, the floorplan of the upper floor does not permit enough room for construction of a standard staircase. In most applications, the homeowner may have a trap door (i.e., a door within the floor) with a ladder or shortened staircase, or must access the lower floor from outside the home. Existing trap doors may be difficult to use, and also present an eyesore to most homeowners. Because of that, many homeowners cover their trap doors with furniture or rugs, further reducing the use of the lower level.

### SUMMARY

Generally, a secure box assembly for a floor structure may include a frame body coupled between joists within the floor structure and defining a cavity therein, an uppermost portion of the frame body being aligned with an upper surface of the floor structure. The secure box assembly may also include a door having a first major surface facing the cavity of the frame body and a second major surface opposite the first major surface, a hinge assembly coupled between the frame body and the first major surface, and at least one powered arm coupled between the frame body and the first major surface and configured to pivot the door between an open state and a closed state. The door may be flat and flush with the upper surface of the floor structure in the closed state.

In some embodiments, the door may comprise a cover layer carried by the second major surface, the cover layer matching the upper surface of the floor structure. The frame body may be anchored to the joists of the floor structure. The hinge assembly may comprise first and second hinges, each hinge comprising first and second pivoting arms. The first and second pivoting arms may be coupled together at a pivot point.

The at least one powered arm may comprise a hydraulic piston configured to operate in an extended state in the open state, and a retracted state in the closed state. The at least one powered arm may comprise a motor configured to switch the hydraulic piston between the extended state and the retracted state. The at least one powered arm may comprise a local power source configured to power the motor. The local power source may comprise at least one of a battery carried by the frame body, and an infrastructure power interface.

Another aspect is directed to a method for making a secure box assembly for a floor structure. The method may include forming a frame body to be coupled between joists within the floor structure and defining a cavity therein, an uppermost portion of the frame body being aligned with an upper surface of the floor structure. The method may also include positioning a door having a first major surface facing the cavity of the frame body and a second major surface opposite the first major surface, coupling a hinge assembly between the frame body and the first major surface, and coupling at least one powered arm between the frame body and the first major surface and configured to pivot the door between an open state and a closed state. The door may be flat and flush with the upper surface of the floor structure in the closed state.

### BRIEF DESCRIPTION OF THE DRAWINGS

FIG. 1 is a schematic perspective view of a first example embodiment of an access door assembly, according to the present disclosure.

FIG. 2 is a schematic bottom plan view of the access door assembly of FIG. 1.

FIG. 3A is a schematic cross-sectional view of the access door assembly of FIG. 2 along line A-A.

FIG. 3B is a schematic cross-sectional view of the access door assembly of FIG. 2 along line B-B.

FIG. 4 is a schematic bottom plan view of a second example embodiment of the access door assembly, according to the present disclosure.

FIG. 5 is a schematic cross-sectional view of a third example embodiment of the access door assembly along line A-A.

FIG. 6 is a schematic cross-sectional view of the access door assembly of FIG. 5 along line B-B.

FIG. 7 is a schematic bottom plan view of the access door assembly of FIG. 5.

FIGS. 8A and 8B are enlarged schematic cross-sectional views of the access door assembly of FIG. 5 along line A-A with the access door in a closed state and an open state, respectively.

FIGS. 9-10 are schematic perspective views of an example embodiment of a secure box assembly in an open state, according to the present disclosure.

FIG. 11 is a schematic side view of the secure box assembly from FIG. 9 in the open state with a side panel removed and with a cover layer on the door.

FIG. 12 is a schematic cross-sectional view of the secure box assembly from FIG. 9 along line 12-12 in a closed state and with a cover layer on the door.

FIG. 13 is a schematic perspective view of a hinge from the secure box assembly from FIG. 9.

### DETAILED DESCRIPTION

The present disclosure will now be described more fully hereinafter with reference to the accompanying drawings, in which several embodiments of the invention are shown. This present disclosure may, however, be embodied in many different forms and should not be construed as limited to the embodiments set forth herein. Rather, these embodiments are provided so that this disclosure will be thorough and complete, and will fully convey the scope of the present disclosure to those skilled in the art. Like numbers refer to like elements throughout, and base 100 reference numerals are used to indicate similar elements in alternative embodiments.

Generally, an access door assembly is for a floor structure. The access door assembly may include a door frame coupled to the floor structure and defining an opening aligned with a staircase, an access door within the opening, a hinge coupled between the door frame and the access door and pivoting the access door between an open state and a closed state, and at least one arm coupled between the door frame and the access door and configured to switch the access door between the open state and the closed state.

Another aspect is directed to a method for making an access door assembly for a floor structure. The method may comprise coupling a door frame to the floor structure and defining an opening aligned with a staircase, and positioning an access door within the opening. The method may also include coupling a hinge between the door frame and the access door and for pivoting the access door between an open state and a closed state, and coupling at least one arm between the door frame and the access door and to switch the access door between the open state and the closed state.

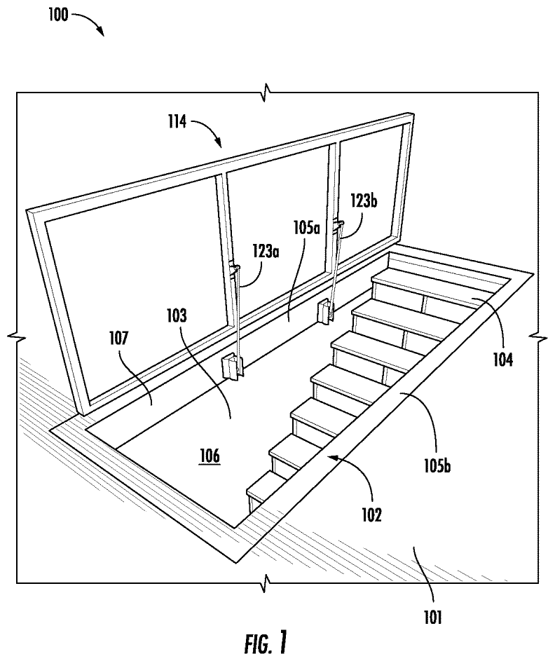

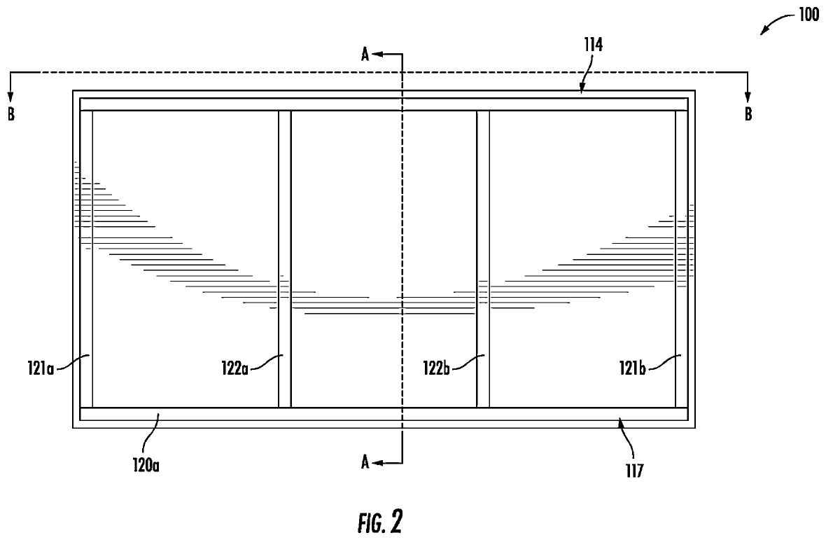

Referring initially to FIGS. 1-3B, an access door assembly 100 according to the present disclosure is now described. As will be appreciated, the access door assembly 100 is to be installed within a floor structure 101 of a building (i.e., commonly known as a trapdoor). The access door assembly 100 illustratively includes a door frame 102 coupled to the floor structure 101 and defining an opening 103 aligned with a staircase 104. Of course, the staircase 104 provides access to a lower level below the floor structure 101, such as a basement, for example.

The door frame 102 illustratively includes first and second longitudinal sides 105a-105b. The first longitudinal side 105a is abutting a wall 106 of the building, and comprises a ledge support 107 coupled to the wall. The first longitudinal side 105a illustratively includes a plurality of fasteners 108a-108b coupling the ledge support 107 to the wall 106. The plurality of fasteners 108a-108b may comprise self-tapping fasteners for coupling to the wall 106, or an arrangement of a C-channel and associated fasteners.

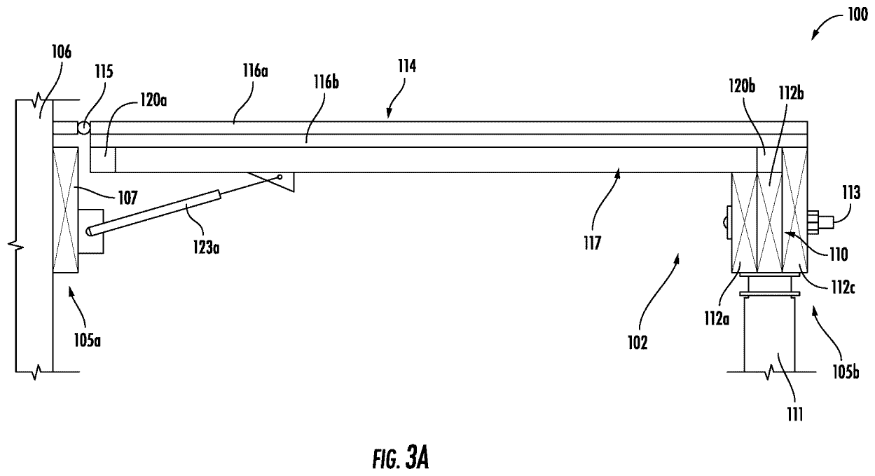

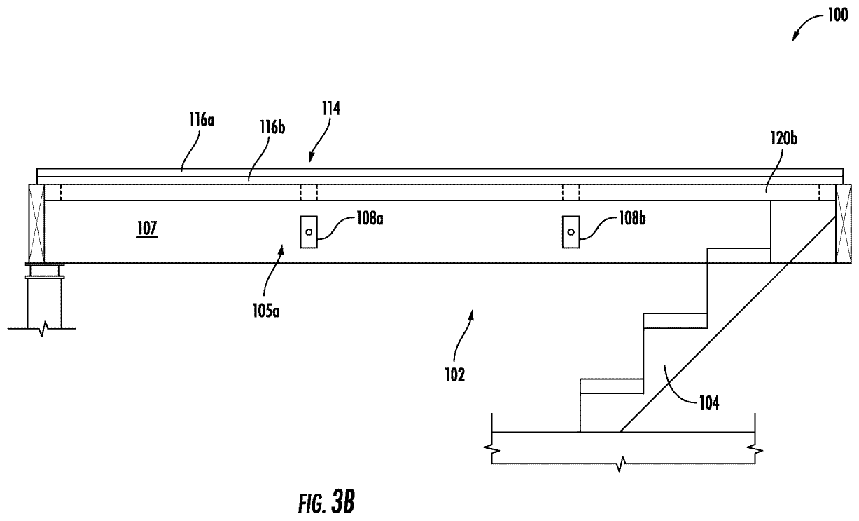

The second longitudinal side 105b is abutting a floor joist 110. As perhaps best seen in FIG. 3A, the floor joist 110 is supported by a column 111 from the lower level. The floor joist 110 illustratively comprises a plurality of structural members 112a-112c, and a plurality of fasteners 113 coupling the plurality of structural members together. For example, the plurality of structural members 112a-112c may each comprise a wood lumber segment, such as a 2 inch by 4 inch by 8 feet lumber piece. For example, the plurality of fasteners 113 may comprise carriage bolts, and associated threaded nuts.

The access door assembly 100 illustratively comprises an access door 114 within the opening 103, and a hinge 115 coupled between the door frame 102 and the access door and pivoting the access door between an open state (FIG. 1) and a closed state (FIG. 3A). In another embodiment, the hinge 115 may be coupled directly to the wall 106.

As perhaps best seen in FIG. 3A, the access door 114 illustratively comprises an upper layer 116a, a lower layer 116b below the upper layer, and a support frame 117 below the lower layer. The upper layer 116a comprises a finished floor surface to match adjacent portions of the floor structure 101, thereby concealing the existence of the access door assembly 100. The lower layer 116 comprises a rigid support layer comprising (i.e., a subfloor), for example, wood, aluminum, or steel. The support frame 117 comprises first and second frame sides 120a-120b, first and second ends 121a-121b extending between the first and second frame sides, and first and second cross members 122a-122b extending between the first and second frame sides. The support frame 117 may comprise any rigid material with sufficient strength to support vertical loads on the access door 114, such as aluminum, or steel, for example.

The access door assembly 100 illustratively comprises first and second arms 123a-123b coupled between the door frame 102 and the access door 114 and configured to switch the access door between the open state and the closed state. In the illustrated embodiment, each of the first and second arms 123a-123b comprises pneumatic struts to bias the access door 114 in the open state.

In other embodiments, the first and second arms 123a-123b may each comprise a motorized arm (e.g. a linear actuator) configured to switch the access door 114 between the open state and the closed state. In these embodiments, the access door assembly 100 is coupled to a power source, such as a grid power receptacle or a battery. Also, the access door assembly 100 may comprise a wireless transceiver and associated remote transmitter for remote opening and closing of the access door 114.

As perhaps best seen in FIG. 3A, the access door 114 provides a secure floor structure while in the closed state. In particular, the second longitudinal side 105b rests securely on the floor joist 110. In particular, the plurality of structural members 112a-112c of the floor joist 110 defines a flanged upper surface for receiving the access door 114. In particular, the upper layer 116a, the lower layer 116b, and the support frame 117 are received by this upper flanged surface. This arrangement prevents the access door 114 from moving laterally. Moreover, the support frame 117 transmits loads from the access door 114 to the floor joist 110 and the wall 106.

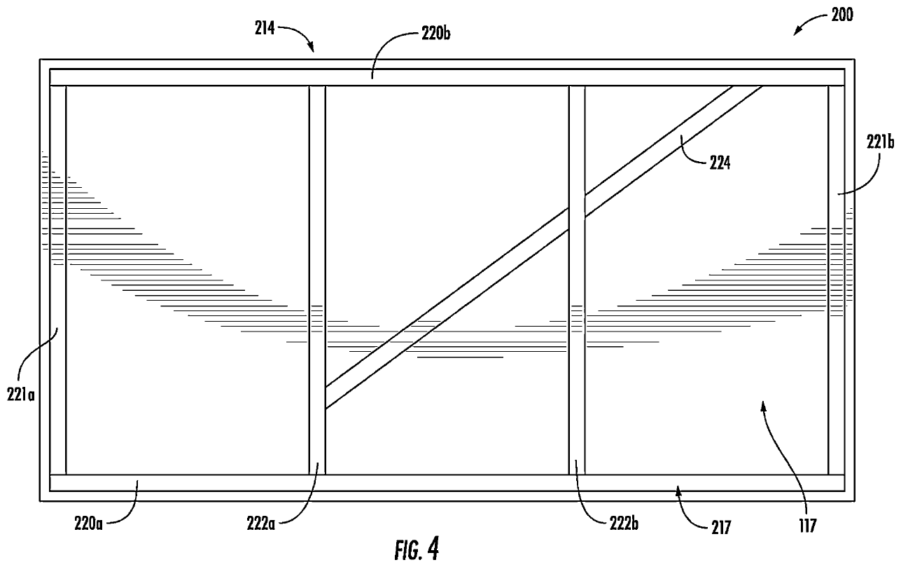

Referring now additionally to FIG. 4, another embodiment of the access door assembly 200 is now described. In this embodiment of the access door assembly 200, those elements already discussed above with respect to FIGS. 1-3B are incremented by 100 and most require no further discussion herein. This embodiment differs from the previous embodiment in that this access door assembly 200 illustratively includes a stair railing 224 coupled to the support frame 217 for providing easy access to the staircase. When the access door 214 is in the open state, the user may maintain a sure and safe grip while navigating the staircase.

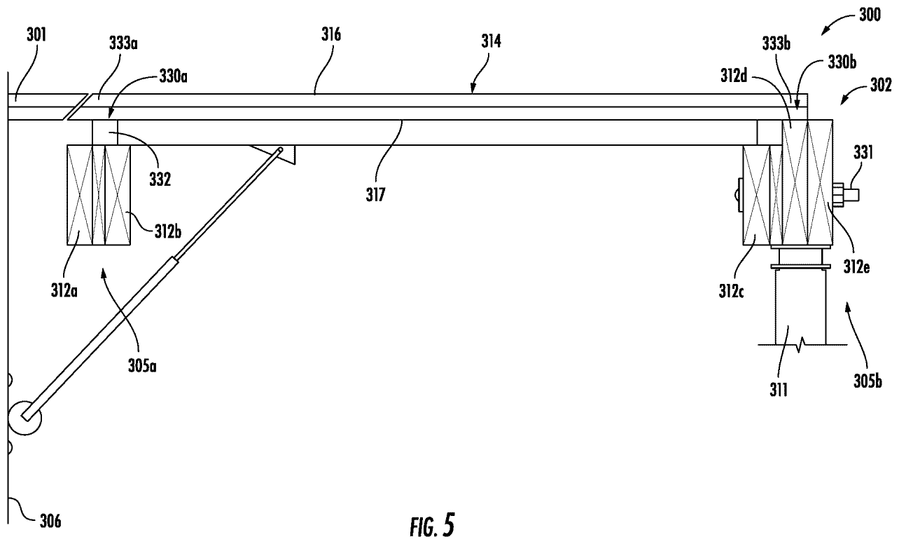

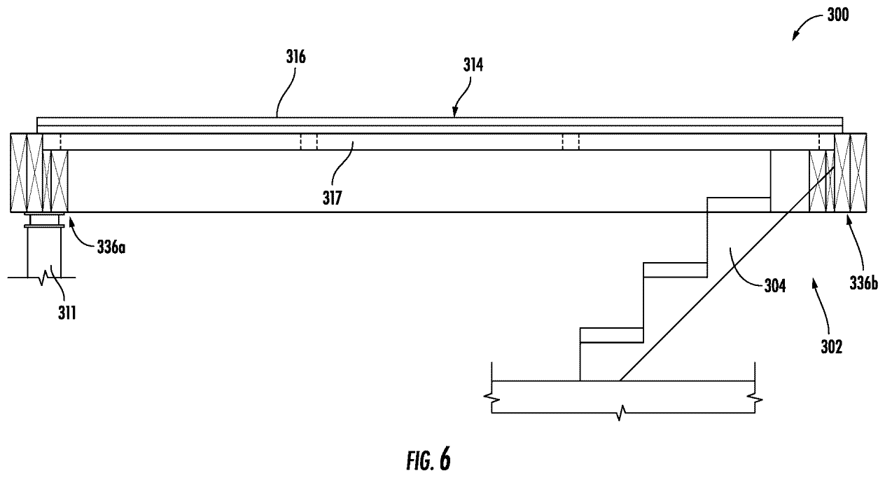

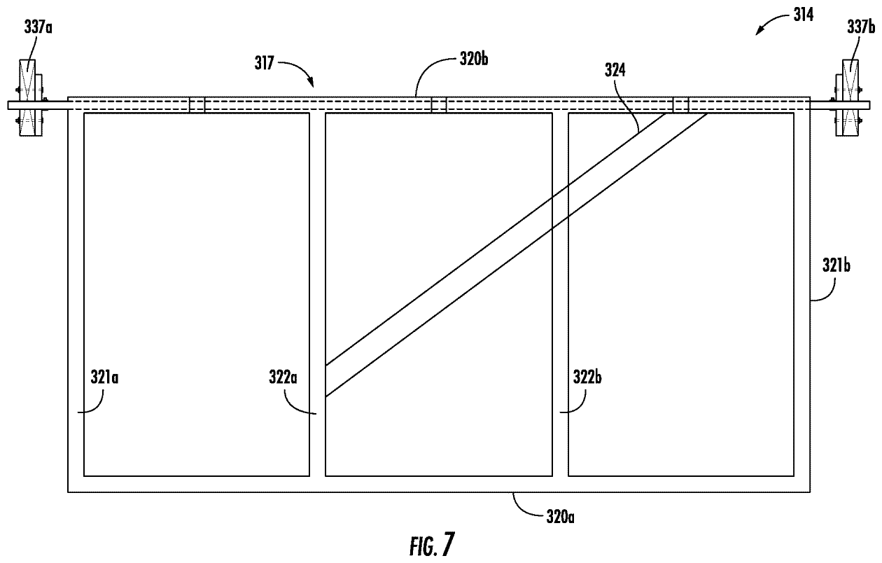

Referring now to FIGS. 5-7 & 8A-8B, an access door assembly 300 is for a floor structure 301. As will be appreciated, the floor structure 301 is on a main floor, and the access door assembly 300 provides access to a lower floor beneath via a staircase 304. The floor structure 301 may comprise a wood floor structure, for example, but may include other flooring types.

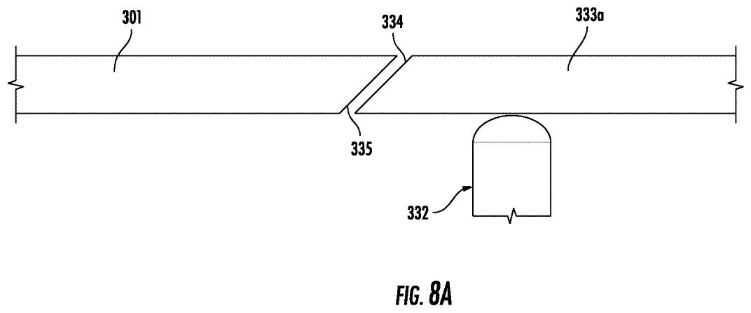

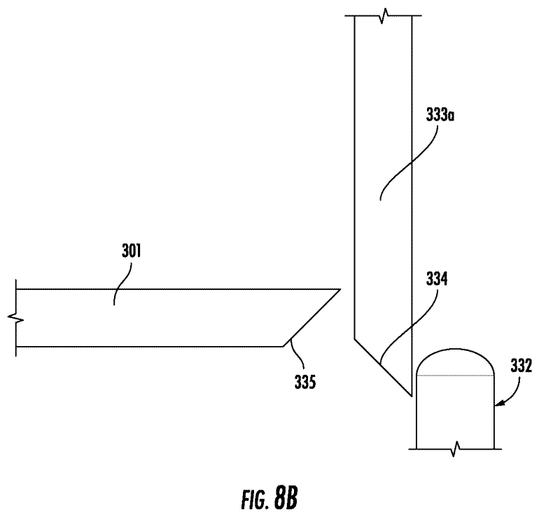

The access door assembly 300 includes a door frame 302 coupled to the floor structure 301 and defining an opening aligned with the staircase 304. The door frame 302 illustratively includes first and second longitudinal door frame sides 305a-305b, and first and second longitudinal door frame ends 336a-336b extending between the first and second longitudinal door frame sides. In particular, the door frame 302 comprises first and second longitudinal supports 330a-330b. Each of the first and second longitudinal supports may comprise a plurality of structural members 312a-312e, and a plurality of fasteners 331 (only one shown) coupling the plurality of structural members together. As perhaps best seen in FIG. 5, the first longitudinal support 330a illustratively comprises a longitudinal protrusion 332 extending upward from the plurality of structural members 312a-312b and defining a pivot point. In this embodiment, the longitudinal protrusion 332 comprises a square cross-section shaped strip. As perhaps best seen in FIGS. 8A-8B, the longitudinal protrusion 332 comprises a strip with a rounded top (e.g. hemispheric shaped top).

The access door assembly 300 illustratively includes include a vertical column 311 extending upward from a lower level and supporting the second longitudinal support 330b. For example, the vertical column 311 may comprise a lally column.

The access door assembly 300 includes an access door 314 within the opening and comprising first and second longitudinal sides 333a-333b. The access door 314 comprises an upper layer 316, and a support frame 317 coupled to the upper layer. The support frame 317 comprises first and second frame sides 320a-320b, first and second frame ends 321a-321b extending between the first and second frame sides, first and second cross members 322a-322b extending between the first and second frame sides, and a railing 324 for the staircase 304 extending diagonally across the second cross member and being coupled to the first cross member. The support frame 317 is centered longitudinally and laterally within the upper layer 316.

As perhaps best seen in FIGS. 5 & 8A-8B, the first longitudinal side 333a defines a first opposing bevelled surface 334, and the floor structure 301 adjacent the opening defines a second opposing bevelled surface 335. Each of the first and second opposing bevelled surfaces 334-335 may comprise a surface canted within an angular range of 30-60 degrees, for example.

The access door assembly 300 also includes an arm 323 coupled to the access door 314 and configured to pivot the access door between an open state (FIG. 8B) and a closed state (FIGS. 5 & 8A). In particular, the access door 314 pivots on the pivot point defined by the longitudinal protrusion 332. The first and second opposing bevelled surfaces 334-335 are aligned and abutting in the closed state, and are in spaced apart relation in the open state. Helpfully, when the access door 314 is in the closed state, an entirety of the door frame 302 may be below the floor structure 301.

In the illustrated embodiment, the arm 323 is coupled between the access door 314 and a building wall 306 extending from a lower level. Of course, in other embodiments, the arm 323 may be coupled to the door frame 302.

Another aspect is directed to a method for making an access door assembly 300 for a floor structure 301. The method comprises coupling a door frame 302 to the floor structure 301 and defining an opening aligned with a staircase 304, and positioning an access door 314 within the opening and comprising first and second longitudinal sides 333a-333b. The first longitudinal side 333a defines a first opposing bevelled surface 334, and the floor structure 301 adjacent the opening defines a second opposing bevelled surface 335. The method further includes coupling at least one arm 323 to the access door 314 and configured to pivot the access door between an open state and a closed state, the first and second opposing bevelled surfaces 334-335 being aligned and abutting in the closed state, and being in spaced apart relation in the open state.

The access door assembly 300 may provide for an approach to the issues with existing approaches. In particular, with the hingeless design of the access door assembly 300, the door frame 302 is completely hidden in the closed state. To the user, the floor structure 301 appears contiguous and uninterrupted, which is aesthetically pleasing.

Moreover, each of the access door assemblies 100, 200, 300 may be retrofitted readily to existing construction, freeing up space in the floor plan of the main floor. Given the demand for renovation and making lower floors accessible when they are currently not, the access door assemblies 100, 200, 300 provide a less costly approach that is safe and easy to use.

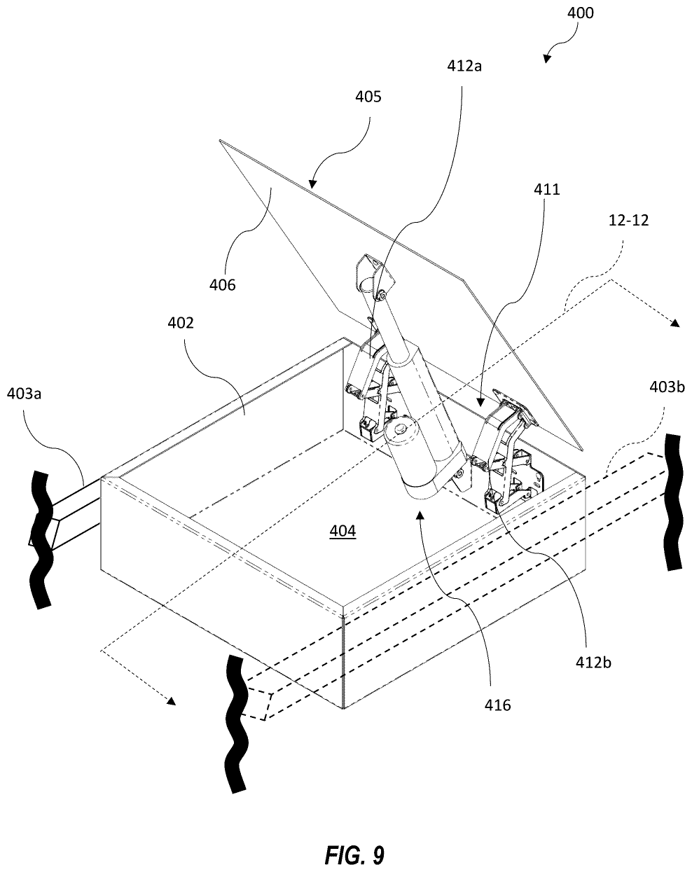

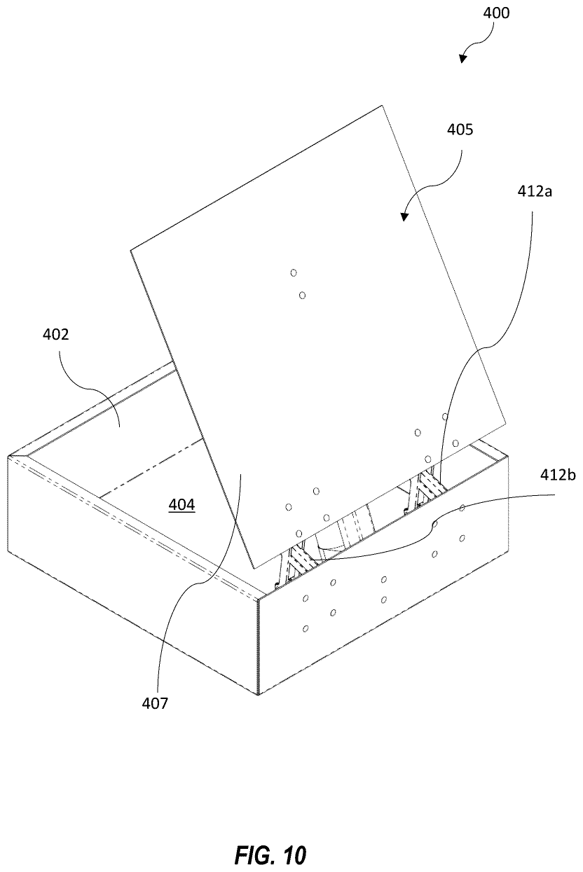

Referring now to FIGS. 9-13, a secure box assembly 400 according to the present disclosure is now described. The secure box assembly 400 is for a floor structure 401. The secure box assembly 400 comprises a frame body 402 coupled between joists 403a-403b (shown partially dashed in FIG. 9) within the floor structure 401 and defining a cavity 404 therein. As will be appreciated, the secure box assembly 400 may provide for a secure floor safe, and the cavity 404 may be for storing valuables. In particular, the frame body 402 may be anchored to the joists 403a-403b of the floor structure 401 to provide for a more secure installation.

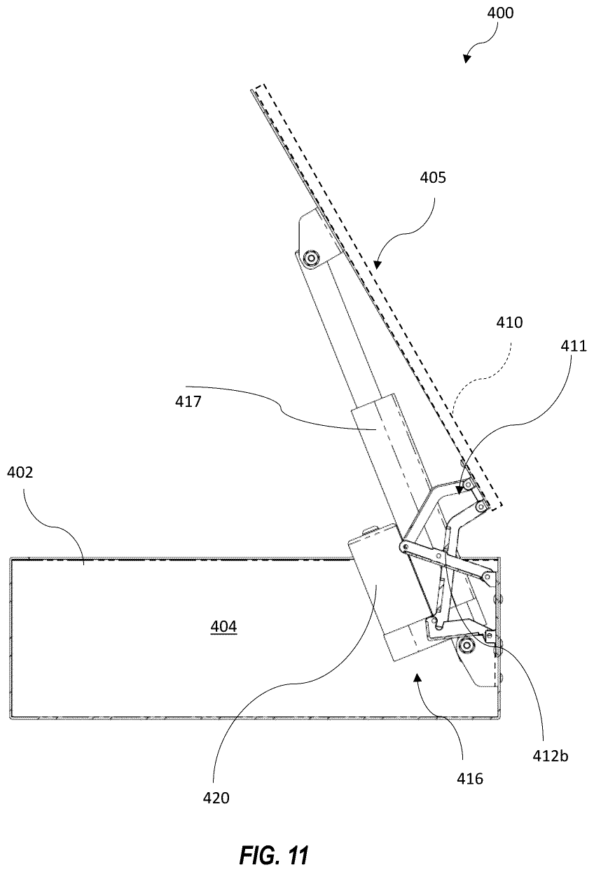

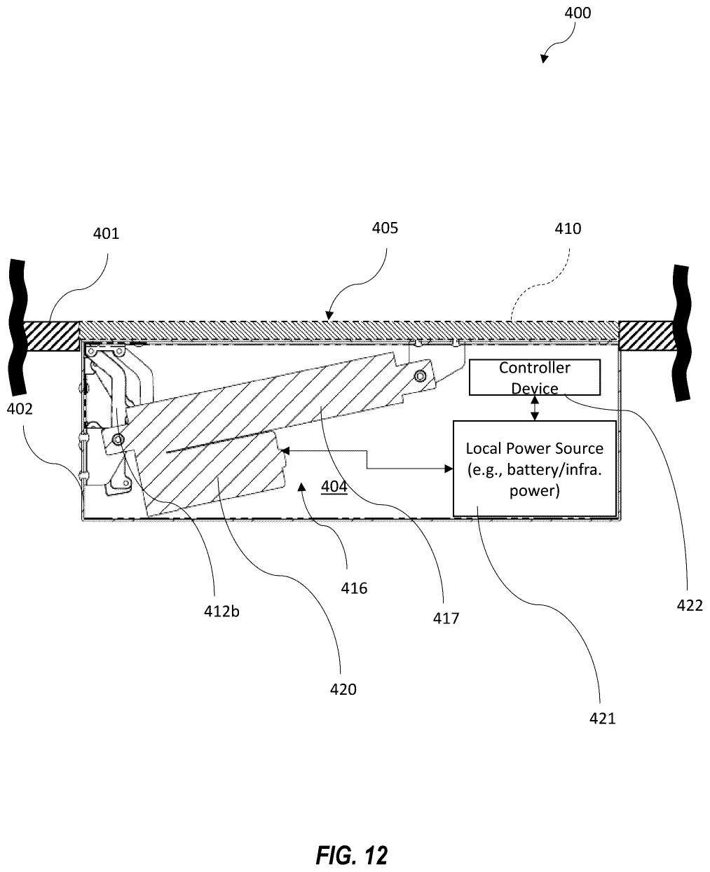

As perhaps best seen in FIG. 12, an uppermost portion of the frame body 402 being aligned with an upper surface of the floor structure 401. The secure box assembly 400 further includes a door 405 having a first major surface 406 facing the cavity 404 of the frame body 402 and a second major surface 407 opposite the first major surface. In some embodiments, the door 405 may comprise a cover layer 410 (shown with dashed lines in FIGS. 11-12) carried by the second major surface 407. The cover layer 410 may match the upper surface of the floor structure 401. In other words, the cover layer 410 is configured to match adjacent portions of the upper surface of the floor structure 401 to conceal a location of the secure box assembly 400.

The door 405 and the frame body 402 may comprise a rigid material with sufficient mechanical strength to provide secure encasement of the cavity 404. For example, this rigid material may comprise a metallic material, such as steel.

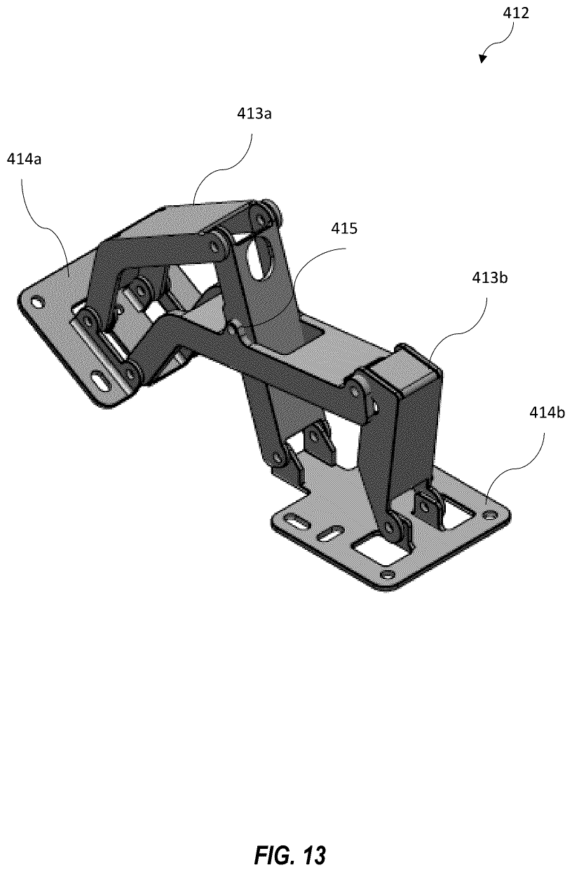

The secure box assembly 400 further includes a hinge assembly 411 coupled between the frame body 402 and the first major surface 406. The hinge assembly 411 illustratively comprises first and second hinges 412a-412b. As perhaps best seen in FIG. 13, each hinge 412a-412b illustratively includes first and second pivoting arms 413a-413b, and first and second mounting plates 414a-414b respectively coupled to an inner surface of the frame body 402 and the first major surface 406. The first and second pivoting arms 413a-413b are coupled together at a pivot point 415. For example, in the illustrated embodiment, the first and second hinges 412a-412b each comprises a 170° concealment hinge.

The secure box assembly 400 further includes a powered arm 416 coupled between the frame body 402 and the first major surface 406 and configured to pivot the door 405 between an open state (providing access to the cavity 404) and a closed state (preventing access to the cavity). More specifically, the door 405 is flat and flush with the upper surface of the floor structure 401 in the closed state. In the illustrated embodiment, the secure box assembly 400 further includes a single powered arm 416, but in other embodiments, more than one power arm may be provided. In some embodiments, the powered arm 416 may comprise passively powered arm, for example, a hydraulic arm biased to extend to the open state.

The powered arm 416 illustratively comprises a hydraulic piston 417 configured to operate in an extended state in the open state, and a retracted state in the closed state. The powered arm 416 comprises a motor 420 configured to switch the hydraulic piston 417 between the extended state and the retracted state. The powered arm 416 comprises a local power source 421 configured to power the motor. The local power source 421 may comprise one or more of a battery carried by the frame body 402, and an infrastructure power interface.

In some embodiments, the secure box assembly 400 illustratively includes a controller device 422 coupled to the powered arm 416. The controller device 422 is configured to cause the powered arm 416 to switch between the extended state and the retracted state based upon a security token. For example, the controller device 422 may comprise a mechanical combination lock device configured to receive the security token comprising a security alphanumeric key, or a biometric lock device configured to receive the security token comprising a biometric security token. In yet other embodiments, the controller device 422 may comprise a wireless controller device in communication with an external user device, such as a mobile device. The wireless controller device may receive the security token wirelessly from the external user device.

Another aspect is directed to a method for making a secure box assembly 400 for a floor structure 401. The method includes forming a frame body 402 to be coupled between joists 403a-403b within the floor structure 401 and defining a cavity 404 therein, an uppermost portion of the frame body being aligned with an upper surface of the floor structure. The method also includes positioning a door 405 having a first major surface 406 facing the cavity 404 of the frame body 402 and a second major surface 407 opposite the first major surface, coupling a hinge assembly 411 between the frame body and the first major surface, and coupling at least one powered arm 416 between the frame body and the first major surface and configured to pivot the door between an open state and a closed state. The door 405 is flat and flush with the upper surface of the floor structure 401 in the closed state.

Advantageously, the secure box assembly 400 may provide for a secure and readily hidden safe for the user. Positively, this secure box assembly 400 is contained within the floor structure 401, which provides security due to lack of access and concealment. Further, with wireless embodiments, the user can easily access the secure box assembly 400 with complex steps.

It should be appreciated that the individual features from each of the access door assemblies 100, 200, 300 and the secure box assembly 400 may be combined with the other embodiments.

Many modifications and other embodiments of the present disclosure will come to the mind of one skilled in the art having the benefit of the teachings presented in the foregoing descriptions and the associated drawings. Therefore, it is understood that the present disclosure is not to be limited to the specific embodiments disclosed, and that modifications and embodiments are intended to be included within the scope of the appended claims.

1. A secure box assembly for a floor structure, the secure box assembly comprising:
a frame body coupled between joists within the floor structure and defining a cavity therein, an uppermost portion of the frame body being aligned with an upper surface of the floor structure;
a door having a first major surface facing the cavity of the frame body and a second major surface opposite the first major surface;
a hinge assembly coupled between the frame body and the first major surface; and
at least one powered arm coupled between the frame body and the first major surface and configured to pivot the door between an open state and a closed state, the door being flat and flush with the upper surface of the floor structure in the closed state.

2. The secure box assembly of claim 1 wherein the door comprises cover layer carried by the second major surface, the cover layer matching the upper surface of the floor structure.

3. The secure box assembly of claim 1 wherein the frame body is anchored to the joists of the floor structure.

4. The secure box assembly of claim 1 wherein the hinge assembly comprises first and second hinges, each hinge comprising first and second pivoting arms.

5. The secure box assembly of claim 4 wherein the first and second pivoting arms are coupled together at a pivot point.

6. The secure box assembly of claim 1 wherein the at least one powered arm comprises a hydraulic piston configured to operate in an extended state in the open state, and a retracted state in the closed state.

7. The secure box assembly of claim 6 wherein the at least one powered arm comprises a motor configured to switch the hydraulic piston between the extended state and the retracted state.

8. The secure box assembly of claim 7 wherein the at least one powered arm comprises a local power source configured to power the motor.

9. The secure box assembly of claim 8 wherein the local power source comprises at least one of a battery carried by the frame body, and an infrastructure power interface.

10. A secure box assembly for a floor structure, the secure box assembly comprising:
a frame body anchored between joists within the floor structure and defining a cavity therein, an uppermost portion of the frame body being aligned with an upper surface of the floor structure;
a door having a first major surface facing the cavity of the frame body, a second major surface opposite the first major surface, and a cover layer carried by the second major surface, the cover layer matching the upper surface of the floor structure;
first and second hinges coupled between the frame body and the first major surface; and
at least one powered arm coupled between the frame body and the first major surface and configured to pivot the door between an open state and a closed state, the door being flat and flush with the upper surface of the floor structure in the closed state.

11. The secure box assembly of claim 10 wherein each hinge comprises first and second pivoting arms.

12. The secure box assembly of claim 11 wherein the first and second pivoting arms are coupled together at a pivot point.

13. The secure box assembly of claim 10 wherein the at least one powered arm comprises a hydraulic piston configured to operate in an extended state in the open state, and a retracted state in the closed state.

14. The secure box assembly of claim 13 wherein the at least one powered arm comprises a motor configured to switch the hydraulic piston between the extended state and the retracted state.

15. The secure box assembly of claim 14 wherein the at least one powered arm comprises a local power source configured to power the motor.

16. The secure box assembly of claim 15 wherein the local power source comprises at least one of a battery carried by the frame body, and an infrastructure power interface.

17. A method for making a secure box assembly for a floor structure, the method comprising:
forming a frame body to be coupled between joists within the floor structure and defining a cavity therein, an uppermost portion of the frame body being aligned with an upper surface of the floor structure;
positioning a door having a first major surface facing the cavity of the frame body and a second major surface opposite the first major surface;
coupling a hinge assembly between the frame body and the first major surface; and
coupling at least one powered arm between the frame body and the first major surface and configured to pivot the door between an open state and a closed state, the door being flat and flush with the upper surface of the floor structure in the closed state.

18. The method of claim 17 wherein the door comprises cover layer carried by the second major surface, the cover layer matching the upper surface of the floor structure; and wherein the frame body is anchored to the joists of the floor structure.

19. The method of claim 17 wherein the hinge assembly comprises first and second hinges, each hinge comprising first and second pivoting arms; and wherein the first and second pivoting arms are coupled together at a pivot point.

20. The method of claim 17 wherein the at least one powered arm comprises a hydraulic piston configured to operate in an extended state in the open state, and a retracted state in the closed state; wherein the at least one powered arm comprises a motor configured to switch the hydraulic piston between the extended state and the retracted state; wherein the at least one powered arm comprises a local power source configured to power the motor; and wherein the local power source comprises at least one of a battery carried by the frame body, and an infrastructure power interface.
